(19) United States
(12) Patent Application Publication
(10) Pub. No.: US 2005/0285300 A1
(43) Pub. Date: Dec. 29, 2005

(54) Plastic articles of enhanced flame resistance and related method

(76) Inventors: George Hairston, Spartanburg, SC (US); John Burns, Simpsonville, SC (US); Warren Stidham, Cohutta, GA (US); Kim Van Voorhis, Rutherfordton, SC (US)

Correspondence Address: James M. Robertson;J.M. Robertson IP Services, LLC, 223 South Pine Street, Spartanburg, SC, 29302, US

(21) Appl. No.: 10/966,886

(22) Filed: Oct. 15, 2004

Related U.S. Application Data
(60) Provisional application No. 60/512,067, filed on Oct. 17, 2003.

(51) Int. Cl. B29C 47/00

(52) U.S. Cl. 264/211; 523/179

(57) ABSTRACT

A plastic composition of moldable or extrudable character having enhanced flame resistance. The plastic composition includes a base polymer intermixed with a non-brominated intumescent flame retardant composition.

### CROSS-REFERENCE TO RELATED APPLICATIONS

This application claims the benefit of and priority from U.S. Provisional Application 60/512,067, the contents of which are incorporated by reference herein in their entirety.

### TECHNICAL FIELD

This invention relates generally to plastic articles such as extruded and molded plastic articles and the like which incorporate a non-brominated flame retardant additive of intumescent character to provide enhanced resistance to flammability.

### BACKGROUND OF THE INVENTION

In a number of environments it is desirable for plastic components to have a degree of flammability resistance. By way of example only, such environments may include automotive and aeronautic applications, appliances, furniture, electronics, building materials, films, fibers and the like.

In the past, flame resistance has typically been achieved in moldable and extrudable plastics by addition of brominated flame retardants. The use of brominated materials such as decobromodiphenyl oxide and polybrominated diphenyl ethers (PBDEs) has been particularly common in such applications. While such materials have provided generally good levels of flame retardancy, it is now believed that such materials may give rise to undesirable health problems in some users.

### SUMMARY OF THE INVENTION

The present invention provides advantages and alternatives over the prior art by providing moldable and extrudable plastics which incorporate an intumescent flame retardant of non-brominated character as well as a method of producing such plastics. The flame retardant may be blended directly with the base polymer prior to molding or extrusion without adversely affecting the character of the final article.

### DESCRIPTION OF PREFERRED EMBODIMENTS

While the present invention has been generally described above and will hereinafter be described in conjunction with certain potentially preferred embodiments procedures, and practices, it is to be understood that in no case is the invention to be limited to such described embodiments, procedures, and practices. On the contrary, it is intended that the present invention shall extend to all alternatives, modifications, and equivalents as may embrace the principles of the present invention within the true scope and spirit thereof.

According to the preferred practice, the flame retardant additive is of a so called “intumescent” character which is characterized by undergoing a swelling and charring when exposed to substantial heat. By way of example only, and not limitation, the flame retardant additive preferably includes a polymer binder such as a latex emulsion and a flame retardant composition intermixed with the polymer binder. According to one preferred practice, the flame retardant composition includes (i) a blowing agent such as melamine, urea, dicyandiamide or combinations thereof; (ii) an acid donor such as ammonium polyphosphate, mono-ammonium phosphate, diammonium phosphate, potassium tripolyphosphate or combinations thereof; (iii) a carbon donor such as dipentaerythritol (DPE), pentaerythritol, polyol, or a combinations thereof; and (iv) a chlorinated paraffin wax.

The constituents of the flame retardant composition are preferably provided in powder or a granule form and dispersed in a solvent such as water, alcohols, napthas, aromatic hydrocarbon, or a combinations thereof prior to mixing with the binder. Other ingredients such as fillers, pigments and the like may also be added as desired to facilitate compatibility with the base plastic.

According to one potentially preferred practice the flame retardant composition will contain about 0 to 90 percent by weight melamine, more preferably about 10 to 80 percent melamine and most preferably about 40 percent by weight melamine. The flame retardant composition will preferably contain about 0 to 90 percent by weight ammonium polyphosphate, more preferably about 5 to 40 percent by weight ammonium polyphosphate and most preferably about 20 percent by weight ammonium polyphosphate. The flame retardant composition will preferably contain about 0 to 90 percent by weight chlorinated paraffin wax, more preferably about 5 to 40 percent by weight chlorinated paraffin wax and most preferably about 20 percent by weight chlorinated paraffin wax. By way of example only, One such chlorinated paraffin wax which is believed to be suitable is marketed under the trade designation CHLOROWAX 70 from Dover Chemical in Dover Ohio. The flame retardant composition will preferably contain about 0 to 90 percent by weight pentaerythritol, more preferably about 5 to 40 percent by weight pentaerythritol and most preferably about 20 percent by weight pentaerythritol. Of course, all such percentages are exemplary only and may be varied as desired.

It is contemplated that the flame retardant additive (binder plus active ingredients) may be intermixed directly with a base polymer prior to extrusion or molding such as a melt unit feeding into a molding or extrusion station. Thus, it is contemplated that percentages may be readily adjusted as desired thereby providing substantial flexibility.

The invention may be further understood by reference to the following non-limiting examples.

### EXAMPLE 1

An exemplary formula for polystyrene based plastic of enhanced flame resistance is as follows:

| CONSITUENT | ACTIVE % |
|---|---|
| Polystyrene beads | 40 |
| Melamine | 24 |
| Ammonium Polyphosphate | 12 |
| CHLOROWAX 70 (Chlorinated Paraffin Wax) | 12 |
| Pentaerythritol | 12 |

### EXAMPLE 2

An alternative exemplary formula for polystyrene based plastic of enhanced flame resistance and strength is as follows:

| CONSITUENT | ACTIVE % |
|---|---|
| Polystyrene beads | 60 |
| Melamine | 16 |
| Ammonium Polyphosphate | 8 |
| CHLOROWAX 70 (Chlorinated Paraffin Wax) | 8 |
| Pentaerythritol | 8 |

Of course, it is also contemplated that plastic base materials other than polystyrene may be used. By way of example only, such other materials may include polypropylene, polyethylene, polyester and other moldable and extrudable polymeric materials as will be known to those of skill in the art.

It is also contemplated that at least a percentage of the base plastic material may be recycled material derived from previous uses and being reprocessed. In such a practice such recycled materials may be used either alone or in combination with a percentage of virgin feed stock to make up the base plastic.

It will be appreciated that the flame retardant plastics of the present invention may find application in a wide array of uses. By way of example only, such applications may include the formation of large and small scale molded and extruded plastic parts, bulk plastic board stock materials, films, ribbons, fibers and the like. Such materials may be used as formed or further processed into another form as desired for final end use application.

While the present invention has been described in relation to certain potentially preferred embodiments and practices, it is to be understood that such embodiments and practices are illustrative and exemplary only and that the present invention is in no event to be limited thereto. Rather, it is contemplated that modifications and variations to the present invention will no doubt occur to those of skill in the art upon reading the above description and/or through a practice of the invention. It is therefore contemplated and intended that the present invention shall extend to all such modifications and variations which incorporate the broad principles of the present invention within the full spirit and scope thereof.

1. A plastic composition of moldable or extrudable character comprising at least one base polymer intermixed with a non-brominated intumescent flame retardant composition such that the plastic composition is provided with enhanced flame resistance.

2. The invention as recited in claim 1, wherein the flame retardant composition comprises an acid donor, a carbon donor and a blowing agent.

3. The invention as recited in claim 1, wherein the flame retardant composition comprises an acid donor, a carbon donor and a blowing agent and a chlorinated paraffin wax.

4. The invention as recited in claim 1, wherein the base polymer is polystyrene.

5. The invention as recited in claim 1, wherein the base polymer is polypropylene.

6. The invention as recited in claim 1, wherein the base polymer is polyethylene.

7. The invention as recited in claim 1, wherein the base polymer is polyester.

8. A method of forming a plastic article comprising the steps of:
providing a melted base polymer to an extrusion station;
intermixing a non-brominated intumescent flame retardant composition into the melted base polymer at the extrusion station; and
extruding the melted base polymer in blended relation with the flame retardant composition.

9. The invention as recited in claim 8, wherein the flame retardant composition comprises an acid donor, a carbon donor and a blowing agent.

10. The invention as recited in claim 8, wherein the flame retardant composition comprises an acid donor, a carbon donor and a blowing agent and a chlorinated paraffin wax.

11. The invention as recited in claim 8, wherein the base polymer is polystyrene.

12. The invention as recited in claim 8, wherein the base polymer is polypropylene.

13. The invention as recited in claim 8, wherein the base polymer is polyethylene.

14. The invention as recited in claim 8, wherein the base polymer is polyester.
